(19) United States
(12) Patent Application Publication
(10) Pub. No.: US 2007/0079139 A1
(43) Pub. Date: Apr. 5, 2007

(54) SIGNATURE AUTHENTICATION

(75) Inventor: Richard C. Kim, Phoenix, AZ (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: Dynasig Corporation, Phoenix, AZ (US)

(21) Appl. No.: 11/537,348

(22) Filed: Sep. 29, 2006

Related U.S. Application Data
(60) Provisional application No. 60/722,478, filed on Sep. 30, 2005.

(51) Int. Cl. H04L 9/00; H04K 1/00

(52) U.S. Cl. 713/186; 713/172; 713/175

(57) ABSTRACT

Presented are systems and methods of signature authentication. A signer employs a bio-pen to electronically sign a file. Signature data corresponding to the bodily movements associated with producing the signer's signature are collected and authenticated against a standard. If the signature data is authenticated a signature certificate including the authenticated signature data is generated and assigned to an electronic envelope. Additional data, such as a bio-pen serial number, time stamps, and user identifier can be collected and used for authentication and inclusion in a signature certificate. Assigning the signature certificate secures the contents of the electronic envelope and signature certificate. An electronic envelope may include any number of files of various types. The systems and methods of signature authentication may accommodate more than one signer of an electronic envelope. The authenticity of the contents of an envelope and the associated signature certificate can be invalidated if unauthorized interaction occurs with the electronic envelope, contents, or signature certificate. Authorized viewers/signers are alerted if such unauthorized interaction occurs. Various levels of authorization can be set for each authorized viewer and signer. Authenticated files can be stored on one or more local computers and transmitted among co-signers and viewers, or stored and accessed remotely, such as on a server accessed via a web site, or some combination of both. Records may be maintained of all interactions with a secured envelope.

### CROSS-REFERENCE TO RELATED APPLICATIONS

This non-provisional application claims priority based upon prior U.S. Provisional Patent Application Ser. No. 60/722,478 filed Sep. 30, 2005 in the name of Richard C. Kim, entitled “Remote Signature Authentication,” the disclosure of which is incorporated herein by reference.

### BACKGROUND OF THE INVENTION

This invention relates generally to signature authentication, and more particularly to systems and methods for electronically signing and certifying the contents of electronic files.

Electronic document generation, editing, tracking, and then exchanging copies around the world has become a common place in every business. However, an effective method of truly authenticating a document is still not available. Most legal documents, agreements, contracts and business forms are still printed (in many cases, multiple copies) and then physically sent (sequentially or in parallel) to the various signers and approving parties (often overnight letters) and then eventually back to the originator to be “filed” away for reference. This approach is quite expensive and time consuming. Some shortcuts are taken by using faxed signature pages, email confirmations and verbal approvals, but in the end, “authentic” signatures on paper are still required. Even with all of the above approaches, the authenticity of the “original signed paper document” cannot be guaranteed—both in terms of contents and the person(s) who signed the document. Often, all paper originals, copies, and faxes are saved to have confidence in authenticity, and also all electronic versions end up being saved, including the original files and some graphical representations (such as pdf or scanned images). Keeping track of all documents, especially when the documents include multiple parts (generated from many different programs), is becoming increasingly expensive.

Thus, a need persists for the ability to carry out reliable paperless document authentication.

### BRIEF SUMMARY OF THE INVENTION

Provided are signature authentication systems and methods carried out by collecting signature data from a signer, the data associated with the signer's bodily movements that correspond to producing a signature; receiving a bio-pen serial number; authenticating the signature data against a standard; generating a signature certificate if the signature data is authenticated, the signature certificate comprising the authenticated signature data and bio-pen serial number; and assigning the signature certificate to an electronic envelope. In various embodiments, assigning the signature certificate to an electronic envelope secures the contents of the electronic envelope and the signer's certification of the contents.

Also provided are dispersion modeling systems including a bio-pen having a serial number; a signer 1 having signature data that is unique to signer 1; a signer 2 having signature data that is unique to signer 2; a storage module for registering and storing standards; an electronic envelope that holds one or more files for transmission of the files to signers and viewers; a signature certificate that indicates the authenticity of the contents of the electronic envelope and the signer's certification of the contents; and a transaction module that authenticates signature data against a standard.

### BRIEF DESCRIPTION OF THE DRAWINGS

FIG. 1 is a block diagram of a system in accordance with embodiments of the present invention.

### DETAILED DESCRIPTION

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical or communicative connection. Thus, if a first component couples to a second component, that connection may be through a direct connection, or through an indirect connection via other devices and connections. It is further noted that all functions described herein may be performed in either hardware or software, or a combination thereof, unless indicated otherwise. Additionally, the terms “a”, “an” and “the” mean “one or more” unless expressly specified otherwise.

For purposes of the present application, the following additional definitions apply: A “bio-pen” is any instrument capable of collecting signature data from a signer/user where the signature data corresponds to bodily movements associated with producing a signature. In some instances the bio-pen is a hand-held instrument and the signature is characterized by moving the instrument along a surface, whether the bio-pen leaves an actual written signature or not. A “signature” is any bodily movement or set of movements capable of uniquely identifying a signer. The signature is typically reproducible so that it can be repeatedly compared to a standard. Further, the signature is not necessarily a written signature or bodily movement(s) that mimics a written signature. A “standard” is data stored or registered electronically, such as on a computer hard drive, server, or portable media (e.g. flash drive, CD, DVD, zip drive, optical disk, floppy disk, and the like), that corresponds to a signer's signature. A standard can be used, for example, when signing and authenticating an electronic document or file by comparing signature data produced when executing a signature against a standard previously created and stored by the signer. Thus, as described in the present application, producing a signature that can uniquely identify a signer in order to electronically authenticate or sign a document/file typically includes completing a repeatable bodily movement (or set of movements) that generates signature data where the signature data can be positively compared against a pre-registered standard. These methods of signing authenticate a file.

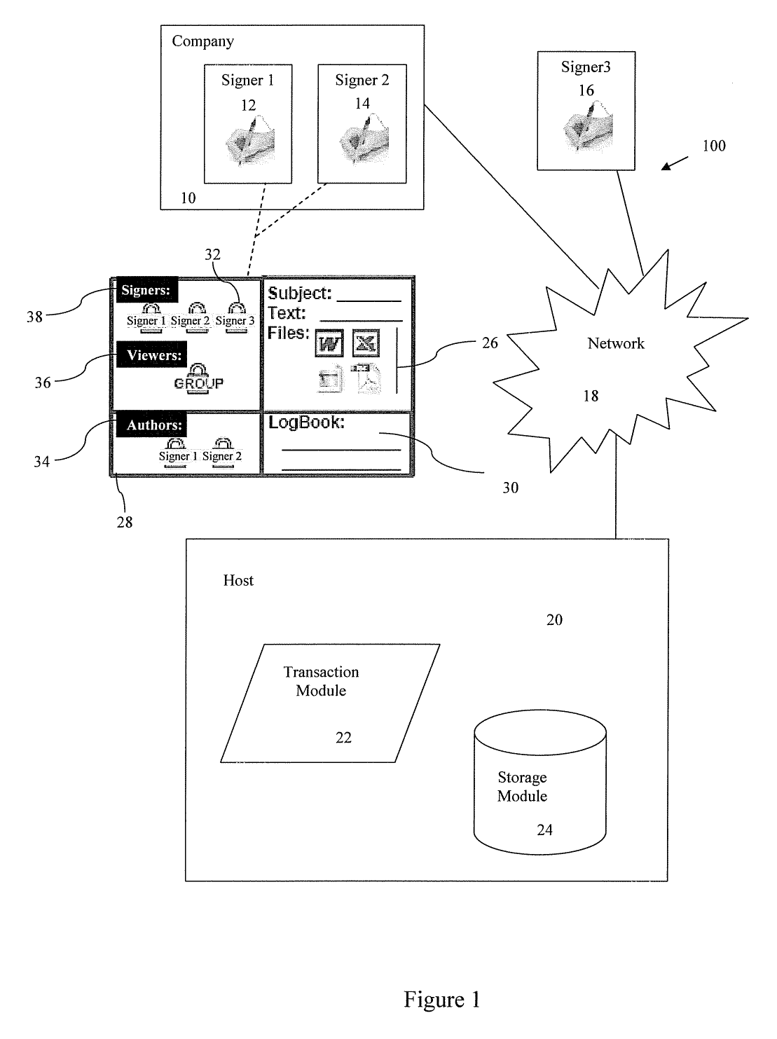

In accordance with various embodiments of the present invention, FIG. 1 is a block diagram of a system 100 for carrying out signature authentication. The system 100 includes an organization (or entity) 10 where files 26 are authored and need authentication and signoff by Signer 1, Signer 2, and Signer 3. Signer 1 and Signer 2 are inside the organization 10 while Signer 3 is outside the organization 10. The organization 10 and Signer 3 are also coupled to a host 20 via one or more networks 18. The host 20, which in this instance is a remote host, includes transaction module 22 that can authenticate signature data and other data against a standard, and a storage module 24, such as a server or other shared storage media, where standards can be registered and stored. Two levels of security are assigned by the author(s) to the files 26 and the envelope 28. A first level of security determines those authorized to open the envelope 28. A second level of security prevents modification of the contents of the files once they have been authenticated/certified. Thus, with appropriate authorization the envelope can be opened without invalidating the contents.

An original author of a file designates other authorized authors and authorized viewers and signers for the file. As illustrated in FIG. 1, the designated signers 38, viewers 36, and authors 34 are indicated in the envelope 28. In this case Signer 1 is the original author, thus Signer 1 designates the list of signers 38, viewers 36, and authors 34, which could be modified by another with the appropriate level of authorization, such as another author. The database of viewers, signers, and authors available to be designated as authorized can be stored either on a server remote to the author or locally on the author's PC. Designating authors, viewers, and signers in an envelope also includes the standard signature data for those authors, viewers, and signers in the envelope. Thus, the standard signature data may also be stored locally or remotely in the database of available viewers, signers, and authors. Once the data is downloaded from the database to an envelope, that data (necessary for authentication and certification) is secure in the envelope regardless of where the envelope is stored, sent, or accessed, and regardless of whether the database of standard data is subsequently compromised.

Various levels of authorization are possible. By way of non-limiting examples, in one setting, anyone with access to the envelope may open the envelope and view the contents. In another setting example, the ability to open the envelope and view the contents (files, log, and designated viewers, signers, and authors) is only granted to those designated that have the appropriate bio-pen serial number and authorized user ID. In a third setting example, a valid bio-pen serial number, user ID, and authenticated signature are all necessary to open an envelope. When the ability to view envelope contents is limited, any combination of bio-pen serial number, user ID, signature data, and the like may be required to gain access. With each different setting, however, the security of the envelope contents and certification(s) are maintained.

Should an unauthorized interaction occur with the envelope and/or envelope contents after assigning a signature certificate to an envelope, authorized viewers/signers of the contents of the envelope are automatically alerted by the system and method. Further, the authenticity of the contents of the envelope is invalidated if an unauthorized interaction occurs with the envelope, contents, or signature certificate. All such alerts, invalidations, locations, users, and other interactions are stored in the envelope's log (e.g. log 30 in FIG. 1).

Once created, an envelope can be copied and stored any number of times and in any number of locations. The ability to view the envelope is not necessarily secure. For example, the original author may create the file and authenticate the file in the envelope, then send copies of the authenticated envelope to the viewers, authors, and other signers so that each has a separate copy of the envelope that at that point has only been authenticated by the original author/signer. Anyone may view, copy, and store the envelope, but only those authorized to view, author, and/or sign can open the envelope. In such a scenario the log associated with each envelope may reflect a different history while the signature authentication and content security will remain identical in all copies.

Each of creation and storage of files and envelopes, viewing envelope contents, and authentication, can be carried out remotely or locally. FIG. 1 includes a remote server. In an embodiment where local authentication is utilized, an author creates a file on his or her local PC, includes the file in an envelope on the PC, designates the authorized list of viewers/signers/authors, certifies/authenticates the file in the envelope on the PC, and saves the file on the PC. The standard signature data required for other viewers, authors, and signers is also secured/sealed in the envelope along with the file contents and the author's certification. A log 30 (FIG. 1) is also sealed in the envelope. The log records any activity associated with the envelope and the envelope's contents.

Files could be one or more electronic files or documents. Non-limiting examples of files for purposes of the present application are word processing, executable, database, image, or spreadsheet files.

In order to authenticate collected signature data, standard signature data must be registered such that the collected signature data may be authenticated against the standard. Such standard signature data may be registered locally or remotely but must remain secure to prevent creation of unauthorized standards. In many embodiments, standard signature data associated with a user (signer, viewer, author) is registered remotely and accessed via a user interface, such as a web site, through a network. When creating an envelope, designating viewers, authors, and signers also includes the standard signature data for those designated users in the envelope. In many embodiments, authentication occurs when signature data is authenticated against the appropriate standard among the designated data in the envelope.

In the instance illustrated by FIG. 1, Signer 1 and Signer 2 are the authors of the files 26. They designate the other Viewers 36 and Signers 38 (in this case Signer 3) of the files. In this case the database of authors, viewers, and signers is registered in a storage module 24 at a remote host 20. The files 26 are set in the envelope 28 that also indicates the Authors 34 and authorized Signers 38 and Viewers 36 of the files 26. Standard signature data necessary for each designated user's access to the envelope and authentication of the files, as appropriate, is also included in the envelope, such as that indicated for Signer 3 32. Once authoring is complete, Signer 1 and Signer 2 employ the bio-pen to produce signatures indicating authentication of the files 26. After authentication that locks/secures the envelope and its contents, the envelope 28 can be submitted to Signer 3 and/or the group of viewers 36.

As Signer 1 (or another designated user) produces the signature with the bio-pen, corresponding signature data are generated and authenticated against the standard data included in the envelope. A serial number associated with the bio-pen used by Signer 1 may also be authenticated against the standard data. A remote or local processor, in this case the transaction module 22 at remote host 20, carries out authentication of the received signature data against the standard and, if the signature is authenticated, generates a signature certificate that includes the Signer's authenticated signature.

In some embodiments, the signature certificate may include additional data such as the bio-pen's serial number, a user identifier (“user ID”), time stamps, organization, location of the bio-pen, and internet protocol (IP) address. In further embodiments, such additional data may be used in combination with the signature data to authenticate a signature. The signature certificate is ‘fused’ with and thus secures/locks the contents of the envelope. Each signer's authentication likewise generates a signature certificate that includes the signer's signature data and secures/locks the contents of the envelope and files. The signature certificate(s) secures the contents of the envelope from any unauthorized interaction, such as viewing, signing, time stamping, date stamping, tampering, altering, copying, saving, and transmitting.

An envelope can contain any number of files of various file types. For example, the same envelope may contain a spreadsheet file, a photo file, and a word processing file, or any other number and combination of files. All of the files can be contained, secured, and authenticated in the same electronic envelope. In some embodiments, any number of files in an envelope can be separately authenticated. Each file may be assigned a different security authorization level and have its own set of authorized viewers/signers.

Once the envelope containing the file and the certification is secure, the signer can save and/or copy the certified envelope. Additionally, a signer who is also the author of the file in the envelope, can designate any number of authorized signers and viewers who are able to view and possibly approve and authenticate the envelope as appropriate. In the case of FIG. 1, Signer 1 and Signer 2 designate Signer 3 as co-signer of the files in the envelope. Each signer can view all of the designated signers/viewers and observe who of the designated signers has approved the contents of the envelope.

In embodiments of the method and system of the present invention further illustrated by FIG. 1, Signer 1 is the authors of the envelope contents and transmits the certified envelope to designated signers and viewers, in this instance Signer 2 (a co-signer), such as via e-mail attachment. Signer 2 authenticates signature data against the standard in the envelope and is able to open the envelope. The envelope as received by Signer 2 indicates that Signer 1 has approved the envelope contents. Signer 2 approves and signs the document. The signing of the document may also involve authentication in order to certify the files, thus Signer 2 produces Signer 2's signature with Signer 2's bio-pen, and corresponding signature data associated with the signer's bodily movements are collected. The serial number associated with the bio-pen used by Signer 2 is also received. Signer 2's collected signature data is authenticated against a standard for Signer 2 and, if the signature is authenticated, a signature certificate is generated that includes Signer 2's authenticated signature and Signer 2's bio-pen serial number. The signature certificate can also include Signer 2's user ID (e.g.—“Signer 2”, “Bob”, “Jane”, and the like) and/or a time stamp showing the date and time Signer 3's signature certificate is generated. Signer 2's signature certificate is assigned to the electronic envelope. Accordingly, Signer 1's and Signer 2's signature certificates are assigned to the electronic envelope, thus securing the contents of the envelope.

Signer 2 transmits the certified envelope to Signer 3 (another co-signer), such as via e-mail attachment. In this case the transmission from Signer 1 to Signer 2 was within the same organization 10 and network, but Signer 3 is outside the organization and thus the file must be transmitted via a network 18 external to the organization (which may be a network of networks coupled together) to Signer 3. The secure envelope received by Signer 3 indicates that Signer 1 and Signer 2 have approved the envelope contents. Signer 3 also approves the contents, thus Signer 3 produces Signer 3's signature with Signer 3's bio-pen, and corresponding signature data associated with Signer 3's bodily movements are collected. The serial number associated with the bio-pen used by Signer 3 is also received. Signer 3's collected signature data is authenticated against a standard for Signer 3 and, if the signature is authenticated, a signature certificate is generated that includes Signer 3's authenticated signature and Signer 3's bio-pen serial number. The signature certificate can also include Signer 3's user ID and/or time stamp information, among other preferred information. Signer 3's signature certificate is assigned to the electronic envelope. Accordingly, Signer 1's signature certificate, Signer 2's signature certificate, and Signer 3's signature certificate are all assigned to the electronic envelope, thus securely approving the contents of the envelope. Assignment of Signer 3's signature certificate to the electronic envelope marks final approval of the file(s) in the secure and authenticated electronic envelope. Signer 3 may save a copy of the finally approved envelope/file(s) and transmit same to Signer 1, Signer 2, and any authorized viewers of the approved file(s). Each authorized recipient of the envelope can save a copy.

In some embodiments, the transaction module 22 carries out authentication of the combination of collected data (e.g.—user ID, bio-pen serial number, and signature data) necessary for generating a signature certificate. The transaction module can authenticate the collected data against standard data stored locally or in a storage module 24. If the collected data matches the standard data then a signature certificate is generated.

In some embodiments, a signer registers a user ID, bio-pen serial number, and standard signature data that must be matched in order for a signature certificate to be assigned to and secure an electronic envelope. Such registration may occur via a network 18 through a host's 20 web site where the host maintains registration information for a plurality of users (signers, viewers, etc.) in a storage module 24. Users may be coupled or grouped based on pre-existing relationships, such as users within the same organization or users having already established business relationships. Thus, for example, when Signer 1 accesses the database, Signer 1 may designate co-signers and viewers that Signer 1 wishes to authorize to sign/view Signer 1's files from a list known to do business with Signer 1. Once this information is registered, Signer 1 can create a file, request a signature certificate for the file, designate co-signers and viewers of the file, put the file in an electronic envelope, assign the signature certificate to the file, and transmit the certified envelope to the designated signers and viewers. Designation of co-signers and viewers also includes standard data needed for those co-signers' and viewers' authentication in the envelope. One or more of the user ID, bio-pen serial number, and standard signature data may be necessary for authentication. This co-signer/viewer information must be similarly authenticated against the appropriate standard in the envelope before the co-signer/viewer can access the envelope containing the file. The level of authentication required of co-signers/viewers in order to access the certified envelope may vary depending on the security concerns of users.

In alternative embodiments, the operations of authenticating, certifying, and securing files in an electronic envelope can be accomplished either on a single personal computer or on the storage module 24 of a remote host 20. In one instance, signers can each carry out authenticating, certifying, and securing a file in an electronic envelope on their respective local computers, such as if software is installed on their computers by download from a disk or a web site. Alternatively, signers can access web based software for similarly carrying out authenticating, certifying, and securing. A secure electronic envelope can be stored in a single location, such as on a local PC or remote server such as storage module 24. Authorized signers and viewers of the envelope contents, such as Signer 1, Signer 2, and Signer 3, access the envelope remotely on the storage module 24 via a web site (not shown), and the envelope is not transmitted from the storage module 24. Each signer/viewer must be authenticated by the transaction module 22 against a standard in order to access the envelope on the storage module 24. Alternatively, the storage module housing the secure envelope and certification may be separate from the storage module housing the standards against which co-signers/viewers must be authenticated. Requiring that access to the certified envelope occur only remotely while the envelope remains stored on a single storage module 24 or server can give a greater level of confidence in the security of the envelope contents.

Other embodiments include the ability to share one bio-pen among many users and the ability of one person to use multiple user IDs and/or bio-pens at different work/computer stations, e.g.—a PC and a handheld. Also, groups can be defined where all users in the same group can specify signature certificates from a common list that is managed by an administrator.

Although exemplary embodiments of the invention have been disclosed, it will be apparent to those skilled in the art that various changes and modifications can be made which will achieve some of the advantages of the invention without departing from the spirit and scope of the invention. For example, it will be obvious to those reasonably skilled in the art that, although the description was primarily directed to a particular system, other systems could be used in the same manner as that described. Other aspects, such as the specific methods utilized to achieve a particular function, as well as other modifications to the inventive concept are intended to be covered by the appended claims.

What is claimed is:

1. A method comprising:
collecting signature data from a signer wherein the signature data corresponds to the signer's bodily movements associated with producing a signature;
receiving a bio-pen serial number;
authenticating the signature data against a standard;
generating a signature certificate if the signature data is authenticated, the signature certificate comprising the authenticated signature data; and
assigning the signature certificate to an electronic envelope.

2. The method of claim 1 wherein assigning secures the contents of the electronic envelope and the signature certificate.

3. The method of claim 1 wherein the signature certificate further comprises the bio-pen serial number.

4. The method of claim 1 wherein the signature certificate further comprises a user identifier.

5. The method of claim 1 wherein the signature certificate further comprises the date and time the signature certificate is generated.

6. The method of claim 1 further comprising repeating the collecting, receiving, generating, and assigning for more than one signer of the electronic envelope.

7. The method of claim 1 further comprising invalidating the authenticity of the contents and signature certificate if unauthorized interactions occur with the envelope, contents, or signature certificate.

8. The method of claim 1 further comprising alerting viewers and signers if unauthorized interactions occur after assigning a signature certificate.

9. The method of claim 1 wherein anyone with access to the file can view the contents of the file.

10. The method of claim 1 wherein only those authorized to generate a signature certificate can view the contents of the file.

11. The method of claim 1 further comprising designating authorized signers and viewers of the envelope.

12. The method of claim 1 further comprising transmitting the file among co-signers and viewers.

13. The method of claim 1 wherein the envelope comprises a plurality of electronic files of various types.

14. The method of claim 1 further comprising saving the certified envelope.

15. The method of claim 1 further comprising copying the certified envelope.

16. The method of claim 1 wherein the standard is stored locally.

17. The method of claim 1 wherein the standard is stored remotely.

18. The method of claim 1 further comprising registering the standard.

19. The method of claim 1 further comprising maintaining records of all interactions with the electronic envelope, such interactions comprising viewing, signing, dates, times, tampering, alteration, copying, saving, transmitting.

20. A system comprising:
a bio-pen having a serial number;
a signer 1 having signature data that is unique to signer 1;
a signer 2 having signature data that is unique to signer 2;
a storage module for registering and storing standards;
an electronic envelope that holds one or more files for transmission of the files to signers and viewers;
a signature certificate that indicates the authenticity of the contents of the electronic envelope and the signer's certification of the contents; and
a transaction module that authenticates signature data against a standard.

21. The system of claim 18 further comprising one or more viewers.
